(19) United States
(12) Patent Application Publication
(10) Pub. No.: US 2014/0097919 A1
(43) Pub. Date: Apr. 10, 2014

(54) WAVEGUIDE MEMBER

(71) Applicant: JUN-WEI WANG, Shenzhen City (CN)

(72) Inventor: JUN-WEI WANG, Shenzhen City (CN)

(21) Appl. No.: 13/666,899

(22) Filed: Nov. 1, 2012

(30) Foreign Application Priority Data
Oct. 10, 2012 (CN) 2012103811979

(51) Int. Cl. H01P 3/12

(52) U.S. Cl. 333/248; 333/254

(57) ABSTRACT

A waveguide member assembly includes a side plate and a waveguide member. The side plate defines an opening. The waveguide member includes a main body molded integrally by plastic. The main body includes a core portion and a mounting plate extending out from edges of a side of the core portion. The core portion includes a number of waveguide tubes aligning with the opening. A metal layer is coated on an outer side of the main body and inner sidewalls of the waveguide tubes. The mounting plate is fastened to the side plate.

### BACKGROUND

1. Technical Field

The present disclosure relates to a waveguide member.

2. Description of Related Art

Waveguide plates have wide use in preventing electromagnetic radiations. However, conventional waveguide plates are usually made of metal material, such as aluminum alloy, thus leading to high cost, and complicated manufacturing process.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an exemplary embodiment of a waveguide member assembly.

FIG. 2 is an assembled, isometric view of FIG. 1, but viewed from a different perspective.

FIG. 3 is a cross-sectional view taken along the line III-III of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

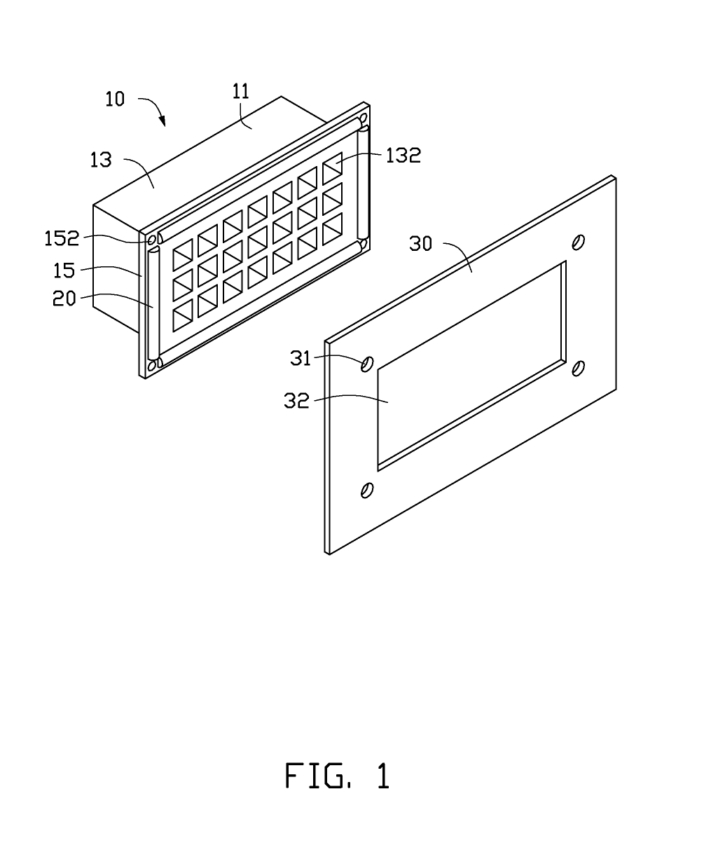

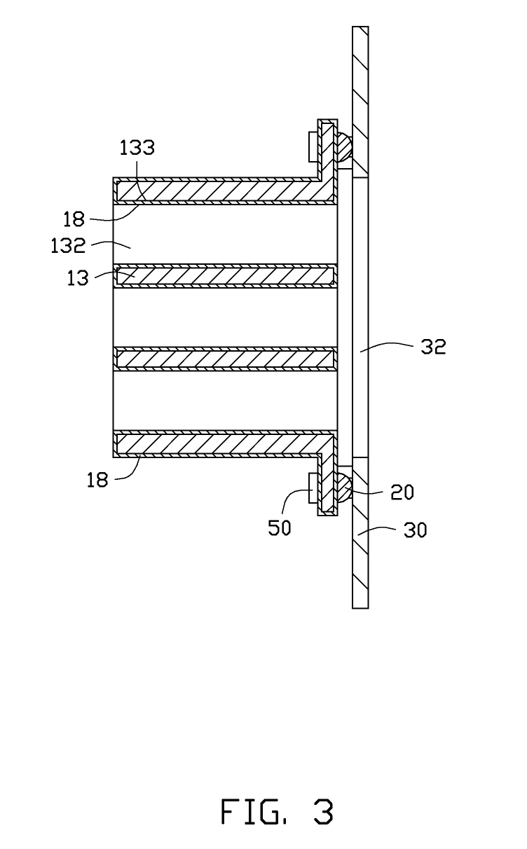

FIGS. 1 and 3 show an exemplary embodiment of a waveguide member assembly including a waveguide member 10, four conductive members 20, and a side plate 30 of an electronic device.

The waveguide member 10 includes a main body 11 injection molded integrally by plastic. The main body 11 includes a core portion 13 and a mounting plate 15 extending out from edges of a side of the core portion 13. The core portion 13 includes a plurality of waveguide tubes 132 substantially perpendicular to the mounting plate 15. Four through holes 152 are defined in four corners of the mounting plate 15, respectively. A metal layer 18 is coated on an outer side of the main body 11 and inner sidewalls 133 of the waveguide tubes 132 by vacuum sputtering.

The side plate 30 defines four locking holes 31, and an opening 32 located among the locking holes 31.

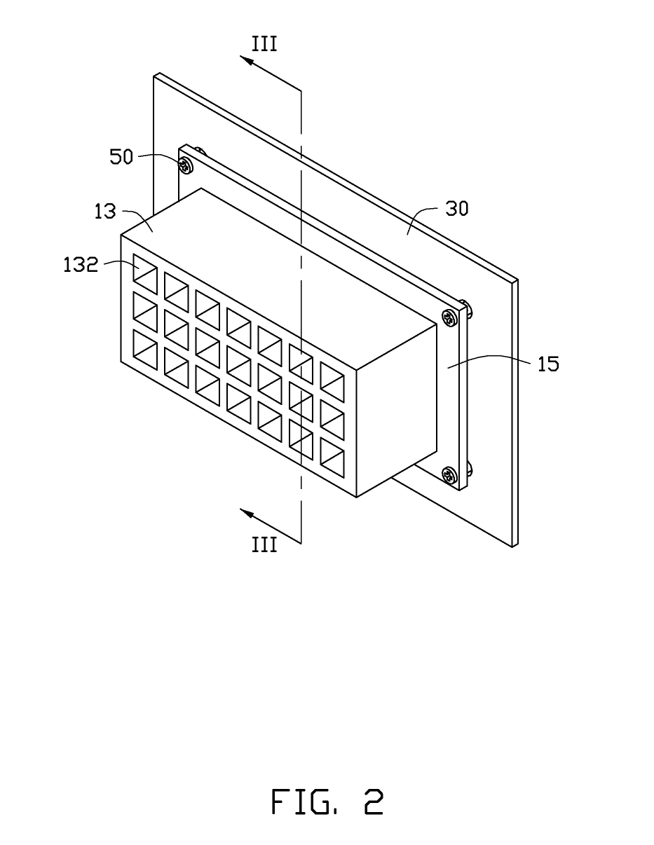

FIGS. 2 and 3 show in assembly, four screws 50 extend through the through holes 152 and engage in the locking holes 31. The waveguide tubes 132 align with the opening 32. The conductive members 20 are sandwiched between the mounting plate 15 and the side plate 30, and are located at edges of the mounting plate 15, to prevent the electromagnetic waves in the electronic device leaking out and prevent the metal layer 18 rubbing the side plate 30. The conductive members 20 may be gaskets pasted on the mounting plate 15 and abutting the side plate 30, or conductive adhesives pasted on the mounting plate 15 and the side plate 30.

In a second embodiment, the conductive members 20 are omitted to reduce cost.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A waveguide member, comprising:
a main body molded by plastic, the main body comprising a plurality of waveguide tubes, a metal layer coated on an outer side of the main body and inner sidewalls of the waveguide tubes.

2. The waveguide member of claim 1, wherein the metal layer is coated on the main body by vacuum sputtering.

3. The waveguide member of claim 1, wherein the main body is injection molded integrally, and comprises a core portion and a mounting plate extending out from edges of a side of the core portion, the waveguide tubes are formed in the core portion and perpendicular to the mounting plate.

4. A waveguide member assembly, comprising:
a side plate defining an opening; and
a waveguide member comprising a main body molded integrally by plastic, the main body comprising a core portion and a mounting plate extending out from edges of a side of the core portion, the core portion comprising a plurality of waveguide tubes aligning with the opening, a metal layer coated on an outer side of the main body and inner sidewalls of the waveguide tubes, the mounting plate fastened to the side plate.

5. The waveguide member assembly of claim 4, wherein the metal layer is coated on the main body by vacuum sputtering.

6. The waveguide member assembly of claim 4, wherein the mounting plate is screwed to the side plate, a plurality of conductive members is sandwiched between the mounting plate and the side plate, the conductive members are located at edges of the mounting plate.

7. The waveguide member assembly of claim 6, wherein each conductive member is a gasket, pasted on the mounting plate and abutting the side plate.

8. The waveguide member assembly of claim 6, wherein each conductive member is a conductive adhesive, pasted on the mounting plate and the side plate.
